(19) United States
(12) Patent Application Publication
(10) Pub. No.: US 2014/0274219 A1
(43) Pub. Date: Sep. 18, 2014

(54) Telecommunication Power System

(71) Applicant: TELECT INC., Liberty Lake, WA (US)

(72) Inventors: Larry O'Neal Reeder, Rockwall, WA (US); David Knaggs, Spokane, TX (US)

(73) Assignee: TELECT INC., Liberty Lake, WA (US)

(21) Appl. No.: 13/828,220

(22) Filed: Mar. 14, 2013

(51) Int. Cl. H04W 52/00; H02J 7/00

(52) U.S. Cl. CPC H04W 52/00; H02J 7/00
USPC 455/573; 29/825; 320/107; 307/23

(57) ABSTRACT

A telecommunication power system comprises a battery recharge bus connected to a load bus via a plurality of contactor control paths. The telecommunication power system continuously cycles battery strings as primary power for loads at telecommunication sites in conjunction with utilizing alternate power sources as secondary power for the loads at the telecommunication sites. The telecommunication power system may be installed in a telecommunication site without removing an existing lead-acid rectifier system.

### BACKGROUND

Power systems for telecommunication sites exist. The power systems utilize a rectified commercial alternating current (AC) power line as primary power for a load at a site. The power systems utilize an internal battery bank as backup power for the load at the site in case the commercial AC power fails. The commercial AC power line maintains the battery bank at a constant “float” voltage until the commercial AC power fails. For example, a lead acid battery bank is arranged on a load bus such that the lead acid battery bank is maintained at a constant float voltage until the commercial AC power fails. Subsequent to the commercial AC power failing, the lead acid battery bank provides power for the load at the site.

While the lead acid battery bank is capable of providing backup power for a load at a site, lead acid battery banks alone are not capable of being the primary power source for the load at the site. This is because the lead acid batteries have only about 400 charge/recharge cycles on average of useable life. Thus, if lead acid batteries were employed as the primary source for the load, the lead acid batteries would need to be replaced with new lead acid batteries after only about 400 cycles. Replacing the lead acid batteries at the site after every 400 cycles would be cost prohibitive. Moreover, these power systems are not suitable for use with other alternate power sources (e.g., solar power, wind power, geothermal power, etc.) to recharge the lead acid batteries. For example, the power systems are not suitable for use with an inconsistent power output of the alternate power sources as compared to a consistent power output of the commercial AC power.

### SUMMARY

This summary is provided to introduce simplified concepts for a telecommunication power system and methods, which is further described below in the Detailed Description. This summary is not intended to identify essential features of the claimed subject matter, nor is it intended for use in determining the scope of the claimed subject matter.

A telecommunication power system and methods are provided to utilize batteries as primary power for loads at telecommunication sites in conjunction with utilizing alternate power sources as secondary power for the loads at the telecommunication sites. In one example, a telecommunications power system comprises a battery recharge bus connected (e.g., electrically connected) to a load bus via a plurality of contactor control paths. The power system may comprise a plurality of battery strings arranged to be primary power sources for at least one load. Each battery string of the plurality of battery strings may be connected to a respective contactor control path of the plurality of contactor control paths.

The power system may further comprise a load control circuit connected to the plurality of battery strings. The load control circuit may be arranged to switch each battery string of the plurality of battery strings on to the load bus or on to the battery recharge bus. A plurality of power sources may be connected to the load control circuit, and arranged to switch each power source of the plurality of power sources on to the battery recharge bus.

The power system may further comprise a site controller communicatively coupled with the plurality of contactor control paths and the load control circuit. The site controller may be arranged to control configurations of the plurality of contactor control paths and control the load control circuit.

In another example, a method of powering a load may comprise providing primary power to a load via a first battery string connected to a first contactor control path having a closed circuit with a load bus, configuring a second contactor control path to have a closed circuit with the load bus, and switching to a second battery string connected to the second control path such that the second battery string provides the primary power to the load instead of the first battery string. The method may include configuring the first contactor control path such that the first contactor control path has a closed circuit with the battery recharge bus, and switching the first battery string off of the load bus and on to the battery recharge bus to be recharged by at least one of a plurality of secondary power sources.

In another example, a method of installing a power system in a telecommunications site may comprise installing a battery recharge bus in the telecommunications site, connecting the battery recharge bus to a load bus via a plurality of contactor control paths, and connecting a battery string of a plurality of battery strings to a respective contactor control path of the plurality of contactor control paths.

### BRIEF DESCRIPTION OF THE DRAWINGS

The detailed description is described with reference to the accompanying figures. The use of the same reference numbers in different figures indicates similar or identical items.

FIG. 1 illustrates an example implementation of a site having a power system capable of using battery strings as primary power in conjunction with alternate energy sources at the wireless site.

FIG. 2 illustrates the power system of FIG. 1 in more detail.

FIG. 3 is a flow diagram that illustrates an example process of powering a load arranged at a remote telecommunications site.

FIG. 4 is a flow diagram that illustrates an example process of installing a power system at a site.

### DETAILED DESCRIPTION

### Overview

This disclosure is directed to a telecommunication power system and methods of using and installing such a system. The power system utilizes batteries as primary power in conjunction with alternate power sources as secondary power for the loads at telecommunication sites. The batteries may include lithium iron phosphate batteries, lithium-ion batteries, lithium-ion polymer batteries, nickel-metal hydride batteries, nickel-cadmium batteries, thin film batteries, potassium-ion batteries, or any other rechargeable batteries having a high level of cycleability as compared to a low cycleability of lead-acid batteries. For example, lead-acid batteries may have a low cycleability of at most about 400 cycles of expected life as compared to lithium-ion batteries having a high cycleability of at least about 5,000 cycles to at most about 20,000 cycles of useable life. As used herein, the term “cycles” is a quantity of discharge/recharge events of a battery before the useable life of the battery expires, and a “high level of cycleability” means at least about 5,000 cycles of expected life.

The telecommunication sites may be remote sites, off-grid cell sites (e.g., sites not connected to the public electrical grid), wireless sites, cellular cites, outside plant sites, co-locate sites, central office sites, or any other site. The sites may be configured to utilize non-renewable energy and/or renewable energy. For example, the sites may be configured to utilize fuel cells, generators (e.g., backup generators), commercially available alternating current (AC) power, solar power (e.g., photovoltaics), wind power (e.g., windmills and/or wind turbines), geothermal power, or the like.

In some of the power system implementations, a battery recharge bus may be connected to a load bus via a plurality of contactor control paths. In some of the power system implementations, each battery string of a plurality of battery strings may be connected to a respective contactor control path of the plurality of contactor control paths. For example, the power system may include three or more battery strings, a first battery string connected to a first contactor control path being used as a primary voltage source, a second battery string connected to a second contactor control path ready to be used as the primary voltage source, and a third battery string connected to a third contactor control path ready to be recharged.

In some of the power system implementations, a load control circuit may be connected to the plurality of battery strings and arranged to switch each battery string on to the load bus or on to the battery recharge bus. The load control circuit may be a voltage control circuit, for example, as described in U.S. patent application Ser. No. 13/664,193, titled “Voltage Control Using Field-Effect Transistors,” the contents of which are incorporated by reference herein in its entirety.

In some of the power system implementations, a site controller (e.g., a site control board) may be arranged to control configurations of the plurality of contactor control paths and control the load control circuit disposed at the site. The site controller may be arranged at the site to receive control signals to control each piece of telecommunication equipment, power device(s), and/or controller(s) disposed at the site. The site controller may be a programmable site controller arranged to manage the switching operations via input/output ports and predefined parameters. The site controller may be a central control board, for example, as described in U.S. patent application Ser. No. 13/094,631, titled “Telecommunication Wireless Control System,” the contents of which are incorporated by reference herein in its entirety.

Traditional telecommunication power systems for remote cell sites have utilized rectified commercial alternating current (AC) power as primary power and an internal battery bank (e.g., lead acid battery strings) as backup power in case of failure of the rectified AC power. The traditional power systems cycle multiple backup battery strings to increase a usable life of the battery strings, charge capacity, and reliability. For example, traditional power systems rely on the constancy of the rectified commercial AC power to recharge the backup battery strings. Because of the reliance of traditional power systems and methods reliance on the rectified commercial AC power to cycle the backup battery stings, the traditional power systems are not capable of managing alternate energy sources (e.g., wind power, solar power, geothermal power, etc.). This is because of the inconsistent power output of the alternate energy sources when compared to the consistent power output of the commercial AC power. Therefore, the traditional power systems are unable to utilize the alternate energy sources to cycle the backup battery strings.

For example, traditional power systems utilize battery stings (e.g., lead acid battery strings) having a low cycleability of at most about 400 cycles. Because of the low cycleability of the lead acid battery strings, the traditional power systems cannot afford to cycle through the lead acid battery strings, and thus do not continuously cycle the lead acid battery strings. Because the traditional power systems cannot continuously cycle the lead acid battery strings, the traditional power systems only cycle the lead acid battery strings when the commercial AC power fails. Having the ability to utilize the inconsistent power output of the alternate energy sources in conjunction with having the ability to continuously cycle battery strings will allow for optimization of a telecommunication site's power consumption and reduce costs.

Because traditional telecommunication power systems do not continuously cycle the lead acid battery strings as primary power, the traditional telecommunication power systems do not employ a battery recharge bus connected to a load bus via a plurality of contactor control paths. Also because traditional telecommunication power systems do not continuously cycle the lead acid battery strings as primary power, the traditional telecommunication power systems do not employ a load control circuit connected to the plurality of battery strings arranged to switch each battery string on to the load bus or on to the battery recharge bus. Further, because traditional telecommunication power systems do not continuously cycle the lead acid battery strings as primary power, traditional telecommunication power systems also do not employ a site controller arranged to control configurations of the plurality of contactor control paths and control the load control circuit disposed at the site.

Accordingly, this disclosure describes systems and methods for utilizing battery strings as primary power, in conjunction with alternate power sources as secondary power, for powering loads at telecommunication sites while making use of the lowest cost energy available, which may result in a reduction of power consumption costs.

### Example Environment

FIG. 1 illustrates an example implementation of a wireless site 102 having a power system 104 capable of using a plurality of battery strings 106(1), 106(2), and 106(N) as primary power in conjunction with alternate power sources 108. While FIG. 1 illustrates three battery strings 106(1) 106(2) and 106(N), any number of battery strings may be utilized by the power system 104 in conjunction with the alternate power sources 108. The ability of lithium iron phosphate batteries and/or other new battery technologies to charge and balance in a relatively short time (e.g., less than one hour) means that as few as three battery strings (e.g., 106(1), 106(2), and 106(N)) may be needed, as long as they are properly sized to meet an amp hour requirement of the site 102. In comparison, lead acid batteries utilized in traditional telecommunication power systems may take up to twenty four hours to recharge. Thus, lead acid batteries utilized in traditional telecommunication power systems must be supplemented with new battery technologies (e.g., lithium iron phosphate battery strings) in order to utilize the plurality of battery strings 106(1)-106(N) as primary power. Stated otherwise, the lead acid batteries utilized in traditional telecommunication power systems must be supplemented with new battery technologies in order to continuously cycle the plurality of battery strings 106(1)-106(N) to be utilized as primary power. For example, because the plurality of battery strings 106(1)-106(N) has a high cycleability (e.g., at least about 5,000 cycles to at most about 20,000 cycles) of useable life, the battery strings 106(1)-106(N) can be discharged/recharged continuously.

FIG. 1 illustrates battery string 106(1) as being utilized as primary voltage, battery string 106(2) as being charged and parked, and battery string 106(N) as being recharged (described in more detail below with regard to FIG. 2). While FIG. 1 illustrates only one battery string as charged and parked, more than one quantity of battery strings may be charged and parked. Similarly, more than one quantity of battery strings may be in various states of being recharged.

A lead acid battery string may include a quantity of twenty four lead acid battery cells, each cell being about 2 Volts (V). The lead acid battery string may have a total string voltage of about 55V. Configurations of lithium iron phosphate battery strings may include lithium iron phosphate battery cells being at least about 3V to at most about 4V, and the lithium iron phosphate battery cells being arranged as 6V cell packs, 7V cell packs, 12V cell packs, and/or 14V cell packs to have a total voltage of at least about 48V direct current (DC) voltage to at most about 54 VDC voltage to operate telecommunication equipment or loads.

FIG. 1 illustrates the alternate power sources 108 may include a rectifier alternating current (AC) power system 110, renewable power sources 112, and a backup generator 114. The rectifier AC power system 110 may be supplied with AC power by commercially available power (e.g., a public utility).

The renewable energy 112 may comprise solar power 112(1) (e.g., photovoltaics), wind power 112(2) (e.g., windmills and/or wind turbines), and/or geothermal power 112(N). While FIG. 1 illustrates the renewable energy 112 comprising solar power 112(1), wind power 112(2), and/or geothermal power 112(N), the renewable energy 112 may comprise additional and/or other renewable and or green energies. For example, the renewable energy 112 may comprise hydropower, biomass power, biofuel power, and/or other renewable and/or green energies.

The backup generator 114 may be arranged to provide AC power to the rectifier AC power system 110 when the commercial power fails. For example, the backup generator 114 may be arranged to provide power during a power outage caused by weather.

FIG. 1 illustrates the power system 104 may comprise a battery recharge bus 116, a load control circuit 118, and/or a controller 120 arranged in the wireless site 102. The battery recharge bus 116 may be arranged in the wireless site 102 to be connected with a load bus to provide for managing recharging of the plurality of battery strings 106(1)-106(N) via the alternate power sources 108.

The load control circuit 118 may be a soft load control circuit for physically switching one or more of the plurality of battery strings 106 and/or the alternate power sources 108 on to the battery recharge bus 116 and/or a load bus. While FIG. 1 illustrates the power system 104 comprising a soft load control circuit, any load control switch(s) may be used. However, by utilizing a soft load control circuit voltage spikes may be reduced or eliminated when switching the battery strings. Moreover, by utilizing a soft load control circuit to switch battery strings, independent control over the alternate power sources 108 is made possible. For example, if a soft load control circuit is not employed to switch the battery strings the alternate power sources 108 must be hard connected to the battery recharge bus 116.

The controller 120 may be a programmable site controller for controlling the power system 104. The controller 120 may be communicatively coupled with the power system 104 via a simple network management protocol (SNMP). For example, the controller 120 may be communicatively coupled with the rectifier AC power system 110 via SNMP. Moreover, the controller 120 may be arranged to be communicatively coupled with various types of rectifier AC power systems in use at existing sites.

FIG. 1 illustrates the power system 104 may include a load distribution 122 arranged to distribute power to one or more load(s) 124(1)-124(N). The one or more load(s) 124(1)-124(N) may be telecommunication equipment utilized for processing and distributing signals in a telecommunication infrastructure. For example, the one or more loads may be digital radios, repeaters, routers, cross-connect panels, modules, splitters, combiners, terminal blocks, backplanes, switches, digital radios, and so forth.

FIG. 2 illustrates the power system 104 of FIG. 1 in more detail. FIG. 2 illustrates a return bus 202 and a load bus 204 arranged to distribute power to at least one load. For example, FIG. 2 illustrates the return bus 202 and the load bus 204 connected to the load distribution 122 arranged to distribute power to one or more load(s) 124(1)-124(N).

FIG. 2 illustrates the battery recharge bus 116 connected to the load bus 204 via a plurality of contactor control paths 206(1), 206(2), 206(3), and 206(N). The battery recharge bus 116 may be connected in parallel to the load bus 204 via the plurality of contactor control paths 206(1), 206(2), 206(3), and 206(N). Each battery string 106(1), 106(2), 106(3), and 106(N) of the plurality of battery strings may be connected to a respective contactor control path of the plurality of contactor control paths 206(1), 206(2), 206(3), and 206(N). Because each battery string 106(1), 106(2), 106(3), and 106(N) of the plurality of battery strings is connected to a respective contactor control path 206(1), 206(2), 206(3), and 206(N) connected in parallel to the battery recharge bus 116 and the load bus 204, each battery string 106(1), 106(2), 106(3), and 106(N) may be connected to either the battery recharge bus 116 or the load bus 204 depending on a configuration of the respective contactor control path 206(1), 206(2), 206(3), and 206(N). For example, a negative terminal of each battery string 106(1), 106(2), 106(3), and 106(N) can be connected to either the battery recharge bus 116 or the load bus 204 depending on an open or closed configuration of the respective contactor control path 206(1), 206(2), 206(3), and 206(N).

For example, each contactor control path of the plurality of contactor control paths 206(1), 206(2), 206(3), and 206(N) may include a first contactor 208(1) connected to the load bus 204 and a second contactor 208(2) connected to the first contactor 208(1) and connected to the battery recharge bus 116. The first and second contactors 208(1) and 208(2) may comprise load control circuitry, relays, contactors, or the like to control the flow of power. The first contactor 208(1) may be in an open or closed state, and the second contactor 208(2) may be in an open or closed state. Each battery string 106(1), 106(2), 106(3), and 106(N) of the plurality of battery strings may be connected between the first contactor 208(1) and the second contactor 208(2) of each contactor control path of the plurality of contactor control paths 206(1), 206(2), 206(3), and 206(N). Thus, the negative terminal of each battery string 106(1), 106(2), 106(3), and 106(N) can be connected to either the battery recharge bus 116 or the load bus 204 depending on an open or closed state of the first contactor 208(1) and an open or closed state of the second contactor 208(2).

FIG. 2 illustrates a closed state of the first contactor 208(1) of the contactor control path 206(1), and an open state of the second contactor 208(2) of the contactor control path 206(1). Thus, the first contactor 208(1) of the contactor control path 206(1) is connected to the load bus 204 and the second contactor 208(2) of the contactor control path 206(1) is not connected to the battery recharge bus 116. Therefore, the contactor control path 206(1) has a closed configuration with the load bus 204, and the negative terminal of battery string 106(1) is connected to the load bus 204.

FIG. 2 illustrates an open state of the first contactor 208(1) of the contactor control path 206(2), and a closed state of the second contactor 208(2) of the contactor control path 206(2). Thus, the first contactor 208(1) of the contactor control path 206(2) is not connected to the load bus 204 and the second contactor 208(2) is connected to the battery recharge bus 116. Therefore, the contactor control path 206(2) has a closed configuration with the battery recharge bus 116, and the negative terminal of battery string 106(2) is connected to the battery recharge bus 116.

FIG. 2 illustrates a closed state of the first contactor 208(1) of the contactor control path 206(3), and a closed state of the second contactor 208(2) of the contactor control path 206(3). Thus, the first contactor 208(1) of the contactor control path 206(3) is connected to the load bus 204 and the second contactor 208(2) is connected to the battery recharge bus 116. Therefore, the contactor control path 206(3) has a closed configuration with the load bus 204 and the battery recharge bus 116, and the negative terminal of battery string 106(3) is connected to the load bus 204 and the battery recharge bus 116.

FIG. 2 illustrates an open state of the first contactor 208(1) of the contactor control path 206(N), and an open state of the second contactor 208(2) of the contactor control path 206(N). Thus, the first contactor 208(1) of the contactor control path 206(N) is not connected to the load bus 204 and the second contactor 208(2) is not connected to the battery recharge bus 116. Therefore, the contactor control path 206(N) has an open configuration with the load bus 204 and the battery recharge bus 116, and the negative terminal of battery string 106(N) is not connected to the load bus 204 or the battery recharge bus 116.

While FIG. 2 illustrates the contactor control path 206(1) having a closed configuration with the load bus 204, the contactor control path 206(2) having a closed configuration with the battery recharge bus 116, the contactor control path 206(3) having a closed configuration with the load bus 204 and the battery recharge bus 116, and the contactor control path 206(N) having an open configuration with the load bus 204 and the battery recharge bus 116, the contactor control paths 206(1)-206(N) may have any of these configurations. For example, the contactor control path 206(1) may have an open configuration with the load bus 204 and the battery recharge bus 116 instead of the closed configuration with the load bus 204.

FIG. 2 illustrates the load control circuit 118 connected to the plurality of battery strings 106(1)-106(N). The load control circuit 118 may be arranged to switch each battery string of the plurality of battery strings 106(1)-106(N) on to the load bus 204 or on to the battery recharge bus 116. FIG. 2 also illustrates the rectifier AC power system 110, the solar power 112(1), and the wind power 112(2) connected to the load control circuit 118. Here, the load control circuit 118 may be arranged to switch the rectifier AC power system 110, the solar power 112(1), and/or the wind power 112(2) on to the battery recharge bus 116. For example, the load control circuit 118 may include a plurality of switches 210(1), 210(2), 210(3), 210(4), 210(5), 210(6), and 210(N) arranged to physically switch the battery strings 106(1)-106(N) on to either the battery recharge bus 116 or the load bus 204, and switch the rectifier AC power system 110, the solar power 112(1), and/or the wind power 112(2) on to the battery recharge bus.

FIG. 2 illustrates a closed state of the switch 210(1) of the load control circuit 118. Thus, because the contactor control path 206(1) has a closed configuration with the load bus 204, the battery string 106(1) is switched on to the load bus 204. With the battery string 106(1) switched on to the load bus 204 and the contactor control path 206(1) having the closed configuration with the load bus 204, the battery string 106(1) may be the primary voltage source for the loads 124(1)-124(N).

FIG. 2 illustrates a closed state of the switch 210(1) of the load control circuit 118. Thus, because the contactor control path 206(1) has a closed configuration with the load bus 204, the battery string 106(1) is switched on to the load bus 204. With the battery string 106(1) switched on to the load bus 204 and the contactor control path 206(1) having the closed configuration with the load bus 204, the battery string 106(1) may be the primary voltage source for the loads 124(1)-124(N) (i.e., an online battery string).

FIG. 2 illustrates a closed state of the switch 210(2) of the load control circuit 118. Thus, because the contactor control path 206(2) has a closed configuration with the battery recharge bus 116, the battery string 106(2) is switched on to the battery recharge bus 116. With the battery string 106(2) switched on to the battery recharge bus 116 and the contactor control path 206(2) having the closed configuration with the battery recharge bus 116, the battery string 106(2) may be recharging (i.e., a charging battery string).

FIG. 2 illustrates an open state of the switch 210(3) of the load control circuit 118. Thus, because the switch 210(3) is open, the battery string 106(3) is switched off of the battery recharge bus 116 and the load bus 204. With the battery string 106(3) switched off of the battery recharge bus 116 and the load bus 204, the battery string 106(3) may be charged and isolated (i.e., a charged and parked battery string).

Similarly, FIG. 2 illustrates an open state of the switch 210(4) of the load control circuit 118. Thus, because the switch 210(4) is open, the battery string 106(4) is switched off of the battery recharge bus 116 and the load bus 204. With the battery string 106(4) switched off of the battery recharge bus 116 and the load bus 204, the battery string 106(4) may be charged and isolated (i.e., a charged and parked battery string in open-circuit mode).

FIG. 2 illustrates a closed state of the switch 210(5) of the load control circuit 118. Thus, because the switch 210(5) is closed, the rectifier AC power system 110 is switched on to the battery recharge bus 116. With the rectifier AC power system 110 is switched on to the battery recharge bus 116, the rectifier AC power system 110 may be providing power to the battery recharge bus 116. Moreover, with the battery recharge bus 116 receiving power from the rectifier AC power system 110, the battery recharge bus 116 may provide power to any of the plurality of battery strings 106(1)-106(N) and/or the load distribution 122 depending on a configuration of each contactor control path 206(1)-206(N). The rectifier AC power system 110 may be switched on to take advantage of off peak power rates of the commercial power.

For example, because the contactor control path 206(2) has a closed configuration with the battery recharge bus 116, the battery recharge bus 116 may be supplying power to the battery string 106(2). Similarly, because the contactor control path 206(3) has a closed configuration with the battery recharge bus 116 and the load bus 204, the battery recharge bus 116 may be supplying power to the loads 124(1)-124(N).

FIG. 2 illustrates an open state of the switch 210(6) of the load control circuit 118. Thus, because the switch 210(6) is open, the solar array system 112(1) is switched off of the battery recharge bus 116. The switch 210(6) may be open because the solar array system 112(1) may not have sufficient voltage to provide power to the battery recharge bus 116. Similarly, FIG. 2 illustrates an open state of the switch 210(N) of the load control circuit 118. Thus, because the switch 210(N) is open, the wind turbine system 112(2) is switched off of the battery recharge bus 116. The switch 210(N) may be open because the wind turbine system 112(2) may not have sufficient voltage to provide power to the battery recharge bus 116.

FIG. 2 illustrates the controller 120 may be communicatively coupled with the plurality of contactor control paths 206(1)-206(N) and the load control circuit 118. The controller 120 may be arranged to control the configurations of the plurality of contactor control paths 206(1)-206(N) and control the load control circuit 118. For example, the controller 120 may control the configurations of the plurality of contactor control paths 206(1)-206(N) and control the switches 210(1)-210(N) of the load control circuit 118 via input/output ports and predefined parameters. The controller 120 may receive status information (e.g., current draw, voltage level, switch state, wind speed, or the like) from the components and/or the network elements at the site 102. For example, the controller 120 may receive voltage levels from the solar array system 112(1), and/or the wind turbine system 112(2). The controller 120 may monitor a voltage and/or a temperature of each battery string 106(1)-106(N), via monitoring circuits arranged with each of the battery strings 106(1)-106(N). For example, each battery string 106(1)-106(N) may have a voltage monitoring circuit arranged with each cell so that each cell stays with each other as they discharge and/or recharge. Moreover, each battery string 106(1)-106(N) may have a circuit board arranged with each cell. The monitoring circuits arranged with each battery string 106(1)-106(N) may connect to an analog-to-digital converter. The analog-to-digital converter may multiplex the data and send the data to the input/output ports of the controller 120.

The controller 120 may perform cycling, discharging, recharging, and/or parking of each of the battery strings 106(1)-106(N) in order to optimize a useable life of the battery strings 106(1)-106(N). Moreover, the controller 120 may perform cycling, discharging, recharging, and/or parking of each of the battery strings 106(1)-106(N) in order to optimize a useable life of the battery strings 106(1)-106(N) while maintaining a constant voltage on the load bus 204. For example, the controller 120 may cycle, discharge, recharge, and/or park any of the battery strings 106(1)-106(N) to maintain a constant voltage of at least about −48 VDC to most about −54 VDC on the load bus 204. The controller 120 may implement any of the cycling, discharging, recharging, and/or parking of any of the battery strings 106(1)-106(N) based on specific events detected by monitoring circuits.

For example, an event may comprise an online battery string dropping below a predetermined voltage threshold. For this event, the controller 120 may establish configurations of the contactor control paths 206(1)-206(N) and control the load control circuit 118 to bring a second fully charged battery string that was previously parked in open-circuit mode on to the load bus 204. For example, the controller 120 may determine the voltage of the online battery string 106(1), providing the primary voltage for the loads 124(1)-124(N), has dropped below the predetermined voltage threshold. The controller 120 may then proceed to establish a closed configuration of the contactor control path 206(3) and switch the open state of the switch 210(3) to a closed state of the switch 210(3) to bring the battery string 106(3), previously charged and parked in open circuit mode, on to the load bus 204.

In one example, the predetermined voltage threshold may be set to about 40V. In another example, the predetermined voltage threshold may be set to about 46V. The predetermined voltage threshold may be set based at least in part on the application of the site 102 and/or a preference of a user.

In another example, an event may comprise a battery string being connected or switched to the battery recharge bus 116 for recharging. For this event, the controller 120 may determine what alternate power sources 108 (e.g., second energy sources) are available for recharging. For example, the controller 120 may determine if the solar power 112(1) and/or wind power 112(2) present a threshold voltage. If the controller 120 determines the solar power 112(1) and/or wind power 112(2) are available (i.e., present a threshold voltage), the controller 120 controls the load control circuit 118 to connect the solar power 112(1) and/or wind power 112(2) to the battery recharge bus 116. For example, the controller 120 may control the load control circuit 118 to switch the open state of the switch 210(6) and/or the switch 210(N) to a closed state of the switch 210(6) and/or the switch 210(N) to connect the solar array system 112(1) and/or the wind turbine 112(2) to the battery recharge bus 116.

Further, in the event that a battery string is being connected or switched to the battery recharge bus 116 for recharging, the controller 120 may determine that the solar power 112(1) and/or wind power 112(2) do not present the threshold voltage. For example, the controller 120 may determine the secondary power sources (e.g., the renewable power sources 112) are not available. If the controller 120 determines that the solar power 112(1) and/or wind power 112(2) are not available (i.e., do not present the threshold voltage), the controller 120 may determine if conditions permit parking the battery string until one or more of the secondary sources become available and/or until an off-peak time of day to access rectified AC commercial power at a lower cost.

The conditions may be, voltage levels of each of the battery strings 106(1)-106(N), a quantity of the battery strings 106(1)-106(N) that are recharged (i.e., a quantity of additional or extra recharged battery strings), and/or an availability of rectified AC power (e.g., availability of commercial power and/or availability of backup generator power), for example. If the controller 120 determines conditions permit parking the battery string, the controller 120 may keep the battery string off of the recharge bus 116 and off of the load bus 204. For example, if the controller 120 determines conditions permit parking the battery string, the controller 120 may configure a contactor control path associated with the battery string to have an open configuration with the load bus 204 and the battery recharge bus 116, and control the control circuit 118 to open the switch associated with the battery string.

However, if the controller 120 determines conditions permit charging the battery string with the rectifier AC power system 110, the controller 120 may control the load control circuit 118 to connect the rectifier AC power system 110 to the recharge bus 116. For example, the controller 120 may control the load control circuit 118 to switch an open state of the switch 210(5) to the closed state of the switch 210(5) to connect the rectifier AC power system 110 to the battery recharge bus 116.

Further, if the controller 120 determines conditions permit charging the battery string with one or more of the renewable power sources 112, the controller 120 may control the load control circuit 118 to connect one or more of the renewable power sources 112 to the recharge bus 116. For example, the controller 120 may control the load control circuit 118 to switch the open state of the switch 210(6) and/or the switch 210(N) to a closed state of the switch 210(6) and/or the switch 210(N) to connect the solar array system 112(1) and/or the wind turbine system 112(2) to the battery recharge bus 116. Moreover, the controller 120 may manage the application of the rectified AC power system 110 and the renewable power sources 112 according to a charging algorithm designed to provide ideal charging conditions for the battery string. For example, the controller 120 may utilize the rectified AC power system 110 to apply constant power (e.g., constant Watts) to the battery string and then utilize the renewable power sources 112 to apply constant current for the last 10 amps to achieve 100% state-of-charge. The controller 120 may apply constant power to the battery string and then switch to apply constant current to the battery string based on monitored values of voltages and temperatures of the battery string and the charging algorithm for the battery string.

Subsequent to charging the battery string, the controller 120 may control the load control circuit 118 to remove the rectified AC power system 110 and/or the renewable power sources 112 from the recharge bus 116. Further, subsequent to charging the battery string, the controller 120 may control the load control circuit 118 to remove the newly charged battery string from the recharge bus 116. The controller 120 may park the newly charged battery string in an open circuit mode (e.g., battery strings 106(3) and 106(N)).

In another example, an event may comprise a battery string being parked in open circuit mode after charging the battery. For this event, the monitoring circuit arranged with the battery string measures a voltage of the battery string after a specified amount of time. For example, the monitoring circuit arranged with the parked battery string may measure a voltage of at least about 45V to at most about 60V about every 4 hours. The monitoring circuit may also measure a temperature of the parked battery string after the specified amount of time. Moreover, the monitoring circuit may measure the voltage and or temperature at each cell of the battery string.

The monitoring circuit may send the values of the measured voltages and/or temperatures to the controller 120. The controller 120 may compare the received values with predetermined values. For example, the controller 120 may compare the received values with a predetermined value for each cell. The predetermined value for the voltage may be about 2.8V and the predetermined value for the temperature may be about 25 degrees Celsius (C). Subsequent to the measured voltage value falling below the predetermined voltage threshold, the controller 120 may configure a configuration of one or more of the contactor control paths 206(1)-206(N) and control the load control circuit 118 to bring the parked battery string back on to the battery recharge bus 116 for recharging.

The controller 120 may also configure a configuration of one or more of the contactor control paths 206(1)-206(N) and control the load control circuit 118 to connect one or more of the alternate power sources 108 to the battery recharge bus 116. The controller 120 may apply the connected one or more alternate power sources 108 to recharge the battery string. For example, the controller 120 may apply voltage provided by the solar array system 112(1) and/or the wind turbine system 112(2) to achieve 100% state-of-charge. The controller 120 may determine the battery string to be at 100% state-of-charge by comparing the received voltage and/or temperatures with the predetermined values.

The controller 120 may then control the load control circuit 118 to remove the connected one or more alternate power sources 108 from the battery recharge bus 116. The controller 120 may also then control the load control circuit 118 to remove the fully charged battery string from the battery recharge bus 116 and park the battery string in an open circuit mode.

In another example, an event may comprise one of the renewable power sources 112 reaching a voltage threshold of the load bus 204. For this event, the controller 120 may determine if a voltage of the solar array system 112(1), wind turbine system 112(2), geothermal system 112(N), or other renewable power source 112 reaches or exceeds the voltage threshold of the load bus 204.

In one example, the voltage threshold of the load bus 204 may be set to about 40V. In another example, the voltage threshold of the load bus 204 may be set to about 46V. If the controller 120 determines a voltage of one of the renewable power sources 112 reaches or exceeds the voltage threshold of the load bus 204, the controller 120 controls the load control circuit 118 to connect the renewable power source 112 to the load bus 204. For example, if the controller 120 determines a voltage of the solar power 112(1) and/or wind power 112(2) meets or exceeds the voltage threshold of the load bus 204 the controller 120 may connect the solar power 112(1) and/or wind power 112(2) to the load bus 204. For example, the controller 120 may configure a configuration of one or more of the contactor control paths 206(1)-206(N) and control the load control circuit 118 to bring the solar power 112(1) and/or wind power 112(2) on to the load bus 204 to provide power to the load(s) 124(1)-124(N).

Further, the controller 120 may configure a configuration of one or more of the contactor control paths 206(1)-206(N) and control the load control circuit 118 to provide power to the load(s) 124(1)-124(N), and simultaneously recharge one or more of the battery strings 106(1)-106(N). Subsequent to the controller 120 determining a voltage of the renewable power source 112 is below the voltage threshold of the load bus 204, the controller 120 may configure a configuration of one or more of the contactor control paths 206(1)-206(N) and control the load control circuit 118 to disconnect or remove the renewable power source 112 from the load bus 204. Subsequent to the removal of the renewable power source 112 from the load bus 204, the battery string may resume providing primary power to the load bus 204.

### Example Process of Powering a Load

FIG. 3 is a flow diagram that illustrates an example process 300 of powering a load (e.g., load(s) 124(1)-124(N)) arranged at a remote telecommunications site (e.g., wireless site 102). In some instances, this process begins at operation 302, which represents providing primary power to the load via a first battery string (e.g., battery string 106(1)) connected to a first contactor control path (e.g., contactor control path 206(1)) having a closed circuit with a load bus (e.g., load bus 204).

Process 300 also includes operation 304, which represents a controller (e.g., controller 120) configuring a second contactor control path (e.g., contactor control path 206(3)), connected to a second battery string (e.g., battery string 106(3)), such that the second contactor control path has a closed circuit with the load bus. In one example, for instance, the controller 120 may be triggered to perform operation 304 based on one or more events. For example, the controller 120 may be triggered to perform operation 304 based on the event that the first battery string (e.g., online battery string) drops below a predetermined voltage threshold (e.g., at least about 40V to at most 46V).

Process 300 may also include operation 306, which represents the controller switching the second battery string on to the load bus such that the second battery string provides the primary power to the load instead of the first battery string. The switching may comprise switching a switch (e.g., switch 210(3)) of a load control circuit (e.g., load control circuit 118) connected to the first and second battery strings to bring the second battery string on to the load bus. For example, the controller may control the load control circuit, connected to the first and second battery strings, to switch the open state of the switch to a closed state of the switch to bring the second battery string, previously charged and parked in open circuit mode, on to the load bus.

Operation 306 may be followed by operation 308, which may represent configuring the first contactor control path such that the first contactor control path has a closed circuit with a battery recharge bus. For example, a battery recharge bus may be coupled with the load bus via the first and second contactor control paths, and the controller may configure the first contactor control path to have a closed circuit with the battery recharge bus and an open circuit with the load bus. Operation 308 may also include switching the first battery string off of the load bus and on to the battery recharge bus to be recharged by at least one of a plurality of secondary power sources (e.g., renewable power sources 112). For example, the controller may control the load control circuit, connected to the first and second battery strings, to switch an open state of a switch (e.g., switch 210(1)) to the closed state of the switch to bring the first battery string, previously providing primary power to the load, on to the recharge bus for recharging by at least one of the plurality of secondary power sources.

Process 300 may include operation 310, which represents determining if one or more of the plurality of secondary power sources are available to recharge the first battery string. For example, the controller may determine if the solar power and/or wind power present a threshold voltage. If one or more of the secondary power sources are available, the controller may switch one or more of the secondary power sources on to the recharge bus to recharge the first battery string. Or, if one or more secondary power sources are not available, the controller may determining if conditions provide for switching the first battery string off of the recharge bus and off of the load bus. For example, the controller may determine voltage levels of each of the battery strings, a quantity of the battery strings that are recharged (i.e., a quantity of additional or extra recharged battery strings), and/or an availability of rectified AC power (e.g., availability of commercial power and/or availability of backup generator power).

Process 300 may be completed at operation 312, which represents the controller configuring the first contactor to keep the first battery string off of the recharge bus and off of the load bus until one or more secondary power sources become available, or configuring the first contactor to keep the first battery string off of the recharge bus and off of the load bus until a cost of rectified alternating current (AC) power is below a threshold.

### Example Process of Installing Power System

FIG. 4 is a flow diagram that illustrates an example process 400 of installing a power system (e.g., power system 104) in a telecommunications site (e.g., wireless site 102). For example, this process may be performed to retrofit or upgrade the site. In some instances, the site may have an existing lead-acid rectifier system (e.g., rectifier AC power system 110) and the site may be retrofit or upgraded with the power system without removing the existing lead-acid rectifier system. By upgrading the site, new battery technologies (e.g., lithium type batteries) may be utilized along with the current lead-acid batteries rather than replacing the existing rectification system. By upgrading the sites with the power system, the upgraded sites will provide greater life, improved performance and increased reliability for the existing lead-acid batteries. For example, the power system may increase the life of an average lead-acid battery in stand-by applications by as much as 150%. Further, the electrical stress of the rectifiers and controls will be reduced. By upgrading the sites, the upgraded sites will utilize alternate energy sources (e.g., renewable energy 112) to reduce commercial electrical usage without replacing expensive power plants.

Process 400 begins at operation 402, which represents installing a battery recharge bus (e.g., battery recharge bus 116) in the telecommunications site. For example, a technician may arrange a battery recharge bus with a chassis, a cabinet, a housing, a battery distribution feeder bay (BDFB), or the like arranged in the telecommunication site.

Process 400 includes operation 404, which represents connecting the battery recharge bus to a load bus (e.g., load bus 204) via a plurality of contactor control paths (e.g., contactor control paths 206(1)-206(N). The load bus may be arranged to distribute power to at least one load (e.g., load(s) 124(1)-124(N)) at the telecommunications site. For example, a technician may arrange a plurality of contactor control paths with a chassis, a cabinet, a housing, a battery distribution feeder bay (BDFB), or the like arranged in the telecommunication site and connect the plurality of contactor control paths with the battery recharge bus and the load bus. Further, the plurality of contactor control paths may be fixed in a battery management panel (e.g., a 3 rack unit (RU), 19 inch mount). Moreover, a technician may simply install the battery management panel in to a rack arranged in the telecommunication site.

Operation 404 may be followed by operation 406, which represents connecting a battery string of a plurality of battery strings (e.g., 106(1)-106(N)) to a respective contactor control path of the plurality of contactor control paths. Process 400 may include operation 408, which represents connecting a first contactor (e.g., first contactor 208(1)) of each of the plurality of contactor control paths to the load bus, and connecting a second contactor (e.g., second contactor 208(2)) of each of the plurality of contactor control paths to the battery recharge bus.

Process 400 may include operation 410, which represents connecting a battery string of a plurality of battery strings between the first contactor and the second contactor of each contactor control path of the plurality of contactor control paths.

Process 400 may continue with operation 412, which represents connecting a load control circuit (e.g., load control circuit 118) to the plurality of battery strings. The load control circuit may be arranged to switch each battery string of the plurality of battery strings on to the load bus or on to the battery recharge bus. Operation 412 may be followed by operation 414, which represents connecting a plurality of power sources (e.g., alternate power sources 108) to the load control circuit. The plurality of power sources may be arranged to be secondary power sources for the at least one load, and the load control circuit may be arranged to switch each power source of the plurality of power sources on to the battery recharge bus.

Process 400 may be completed at operation 416, which represents communicatively coupling a controller (e.g., controller 120) with the plurality of contactor control paths and the load control circuit. The controller may be arranged to control configurations of the plurality of contactor control paths and control the load control circuit.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A power system comprising:
a return bus and a load bus arranged to distribute power to at least one load;
a battery recharge bus connected to the load bus via a plurality of contactor control paths; and
a plurality of battery strings arranged to be primary power sources for the at least one load, wherein each battery string of the plurality of battery strings is connected to a respective contactor control path of the plurality of contactor control paths.

2. The power system of claim 1, wherein each contactor control path of the plurality of contactor control paths comprises:
a first contactor connected to the load bus; and
a second contactor connected to the first contactor and connected to the battery recharge bus.

3. The power system of claim 2, wherein each battery string of the plurality of battery strings is connected between the first contactor and the second contactor of each contactor control path of the plurality of contactor control paths.

4. The power system of claim 1, further comprising a load control circuit connected to the plurality of battery strings, the load control circuit arranged to switch each battery string of the plurality of battery strings on to the load bus or on to the battery recharge bus.

5. The power system of claim 4, further comprising a plurality of power sources arranged to be secondary power sources for the at least one load, the plurality of power sources connected to the load control circuit, and the load control circuit arranged to switch each power source of the plurality of power sources on to the battery recharge bus.

6. The power system of claim 5, wherein the plurality of power sources arranged to be secondary power sources include a rectified alternating current (AC) power source, a solar power source, a wind power source, or a geothermal power source.

7. The power system of claim 5, further comprising a controller communicatively coupled with the plurality of contactor control paths and the load control circuit, the controller arranged to control configurations of the plurality of contactor control paths and control the load control circuit.

8. A method of powering a load arranged at a remote telecommunications site, the method comprising:
providing primary power to the load via a first battery string connected to a first contactor control path having a closed circuit with a load bus;
configuring a second contactor control path, connected to a second battery string, such that the second contactor control path has a closed circuit with the load bus; and
switching the second battery string on to the load bus such that the second battery string provides the primary power to the load instead of the first battery string.

9. The method of powering a load arranged at a remote telecommunications site of claim 8, wherein the switching comprises switching a switch of a load control circuit connected to the first and second battery strings to bring the second battery string on to the load bus.

10. The method of powering a load arranged at a remote telecommunications site of claim 8, wherein a battery recharge bus is coupled with the load bus via the first and second contactor control paths.

11. The method of powering a load arranged at a remote telecommunications site of claim 10, further comprising:
configuring the first contactor control path such that the first contactor control path has a closed circuit with the battery recharge bus; and
switching the first battery string off of the load bus and on to the battery recharge bus to be recharged by at least one of a plurality of secondary power sources.

12. The method of powering a load arranged at a remote telecommunications site of claim 11, further comprising:
determining if one or more of the plurality of secondary power sources are available to recharge the first battery string, and based at least in part on the determining:
switching one or more of the secondary power sources on to the recharge bus to recharge the first battery string if one or more of the secondary power sources are available; or
determining if conditions provide for switching the first battery string off of the recharge bus and off of the load bus if one or more secondary power sources are not available.

13. The method of powering a load arranged at a remote telecommunications site of claim 12, further comprising configuring the first contactor to:
keep the first battery string off of the recharge bus and off of the load bus until one or more secondary power sources become available; or
keep the first battery string off of the recharge bus and off of the load bus until a cost of rectified alternating current (AC) power is below a threshold.

14. A method of installing a power system in a telecommunications site, the method comprising:
installing a battery recharge bus in the telecommunications site; and
connecting the battery recharge bus to a load bus via a plurality of contactor control paths, the load bus arranged to distribute power to at least one load at the telecommunications site.

15. The method of installing a power system in a telecommunications site of claim 14, further comprising connecting a battery string of a plurality of battery strings to a respective contactor control path of the plurality of contactor control paths.

16. The method of installing a power system in a telecommunications site of claim 15, further comprising:
connecting a first contactor of each of the plurality of contactor control paths to the load bus; and
connecting a second contactor of each of the plurality of contactor control paths to the battery recharge bus.

17. The method of installing a power system in a telecommunications site of claim 16, further comprising connecting a battery string of a plurality of battery strings between the first contactor and the second contactor of each contactor control path of the plurality of contactor control paths.

18. The method of installing a power system in a telecommunications site of claim 15, further comprising connecting a load control circuit to the plurality of battery strings, the load control circuit arranged to switch each battery string of the plurality of battery strings on to the load bus or on to the battery recharge bus.

19. The method of installing a power system in a telecommunications site of claim 18, further comprising connecting a plurality of power sources to the load control circuit, the plurality of power sources arranged to be secondary power sources for the at least one load, and the load control circuit arranged to switch each power source of the plurality of power sources on to the battery recharge bus.

20. The method of installing a power system in a telecommunications site of claim 19, further comprising communicatively coupling a controller to the plurality of contactor control paths and the load control circuit, the controller arranged to control configurations of the plurality of contactor control paths and control the load control circuit.
